(19) United States
(12) Patent Application Publication
(10) Pub. No.: US 2016/0028288 A1
(43) Pub. Date: Jan. 28, 2016

(54) PUMP WITH NON-TENSIONED ELECTRICAL CONNECTION

(71) Applicant: Magna Powertrain Hückeswagen GmbH, Huckeswagen (DE)

(72) Inventors: Daniel ZIEHR, Remscheid (DE); Carsten SCZESNY, Bochum (DE); Freddy Schönwald, Huckeswagen (DE); Benjamin Pyrdok, Bergisch Gladbach (DE)

(21) Appl. No.: 14/800,968

(22) Filed: Jul. 16, 2015

(30) Foreign Application Priority Data
Jul. 24, 2014 (DE) 10 2014 214 524.4

(51) Int. Cl. H02K 5/10

(52) U.S. Cl. CPC H02K 5/10

(57) ABSTRACT

A pump having an electric motor, wherein the electric motor is fitted to the pump with a flange and has an electrical contact at the end face of the electric motor. The electric motor is covered with a guiding cover which has a groove which extends from the electrical contacts as far as an outlet opening for laying cables. The groove makes at least one radial direction change and a peripheral edge of the guiding cover seals the electric motor with respect to a flange cover of the pump with sealing of the outlet opening.

### CROSS-REFERENCE TO RELATED APPLICATIONS

This application claims the benefit and priority of German Application No. DE102014214524.4 filed Jul. 24, 2014. The entire disclosure of the above application is incorporated herein by reference.

### FIELD

The present disclosure is directed to a pump having an electrical drive, the electrical drive being fitted to a flange of the pump and having an electrical contact in the direction of the motor shaft.

### BACKGROUND

This section provides background information related to the present disclosure which is not necessarily prior art.

Auxiliary unit vacuum pumps are used in motor vehicles to supply other units, for example, a braking force amplifier, having a reduced pressure of, for example, 100 millibars absolute and low and/or excess pressure. In order, during the provision of the excess or reduced pressure, to be independent of the speed of the motor vehicle drive motor, for example, an internal combustion engine, there are used vacuum pumps which are driven in an electromotive manner and which are generally constructed as vane-cell pumps having at least three rotor vanes.

In order to avoid the use of a lubricant supply and in order to prevent contamination of the air leaving the vacuum pump, dry-running vane-cell pumps are used. As a result of the omission of the lubrication of the dry-running vacuum-pump, high demands are made of the material pair comprising rotor vane/stroke ring of the vacuum pump.

EP2570673 discloses an electric motor vehicle vacuum pump which has a motor module and a pump module which is flange-mounted thereon. The motor module has a stator-side motor coil and a motor shaft which carries a motor rotor. The motor shaft is supported by the housing of the motor module by means of a fixed roller bearing and a non-fixed roller bearing. The pump module in this instance is a dry-running rotary vane pump module having a pump rotor shaft which is supported in a floating manner. The pump rotor shaft therefore does not have a separate bearing, but instead protrudes as a rigid extension of the motor shaft into the pump module. The pump rotor shaft indirectly or directly retains a plurality of rotary vanes which delimit and separate the rotating pump chambers from each other in a peripheral direction.

The electric motor module of such electric motor vacuum pumps must be contacted. The contacts typically extend radially with respect to the motor/pump shaft in many engines which are commercially available. The plug type electrical connection to the motor must in this instance withstand a force of 160 N for a period of 60 seconds without damage.

### SUMMARY

This section provides a general summary of the present disclosure and is not a comprehensive disclosure of its full scope or all of its objects, aspects and features.

An object of the present disclosure is directed to providing an electric pump whose electrical contacts have tensile strength and additionally can be sealed with respect to the atmosphere.

This object is achieved with an electric pump having an electric motor and a pump, the electric motor being fitted to a pump housing of the pump with a flange and having electrical contacts at the end face of the electric motor. The electric motor is covered with a guiding cover having a groove which extends from the electrical contacts as far as an outlet opening for laying cables. The groove is configured to make at least one radial direction change while the peripheral edge of the guiding cover is configured to seal the electric motor with respect to a flange cover of the pump housing with sealing of the outlet opening.

An advantage of the guiding cover according to the present disclosure is that both tension relief of the cables and sealing of the electric motor with respect to external influences are possible. Complex sealing systems are thereby avoided.

It is further advantageous for the guiding cover to comprise a plastic material. As a result of appropriate selection of the plastic material, an adequate sealing function is obtained between the electric motor and the pump housing. In addition, the component can be produced in a simple and cost-effective manner.

It is advantageous in this instance for the guiding cover to have at least one recess for the electrical contacts of the electric motor and for the motor shaft.

For the construction of the pump, it is advantageous for the guiding cover to be surrounded by the flange cover of the pump. Simple inspection of the two subassemblies with respect to each other is thereby ensured, and the structural height remains low. In this instance, the guiding cover advantageously has a structural height which corresponds at least to the thickness of the cable which is present.

An advantageous embodiment of the guiding cover is configured to provide a pair of mirror-symmetrical groove paths with respect to a center axis through the contacts and the outlet opening. However, a configuration which has no mirror-symmetry is also possible.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an exemplary embodiment of a pump having an electric motor and which is constructed in accordance with the teachings of the present disclosure;

FIG. 2 is a top view of a tension relief system associated with the electric motor and constructed according to the invention; and

FIGS. 3A and 3B illustrate an alternative guide cover adapted for use with the electric pump of the present disclosure.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

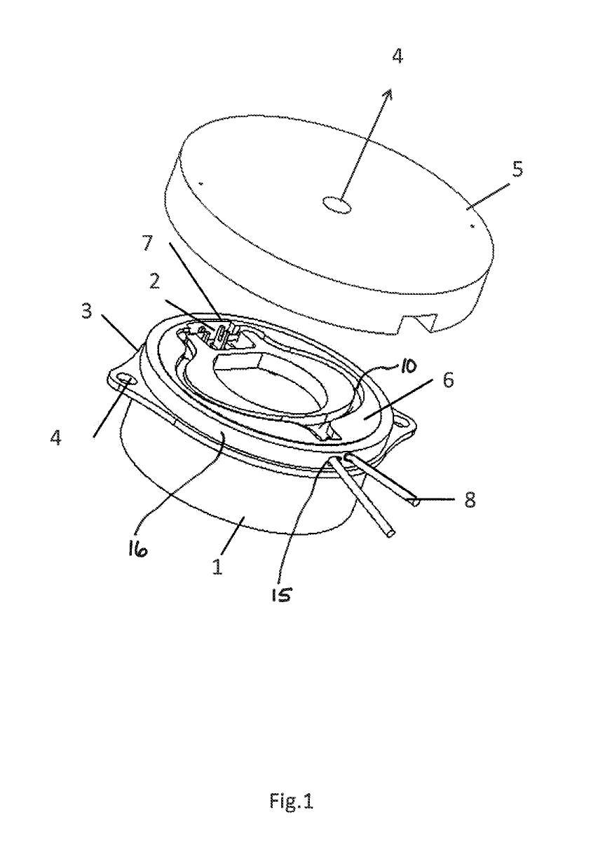

FIG. 1 schematically illustrates the structure of the solution according to the present disclosure in association with an electric motor 1. The electric motor 1 has electric contacts configured as forked poles 2 which extend from the end-face cover thereof parallel with a motor shaft, which is not illustrated in the Figure. The motor 1 additionally has a peripheral mounting flange 3 in which securing screw holes 4 are formed. The motor 1 is connected by means of a flange cover 5 to a pump housing of a pump which is also not illustrated. The electric motor and the pump together define an electric pump. In this instance, between the mounting flange 3 of the motor 1 and the flange cover 5 of the pump housing, no gases or gas admixtures, such as air or fluid, are intended to be introduced into the subassembly. The flange cover 5 has devices to which the flange cover 5 can be secured by means of screw connections to the mounting flange 3. In the prior art, the sealing of the two components with respect to each other is solved by means of a peripheral sealing cord or a moulded seal.

FIG. 1 shows the solution according to the present disclosure to include a guiding cover 6. The guiding cover 6 is, in this non-limiting example, made as a plastic material, injection-moulded component which is adapted in terms of its outer diameter to the electric motor 1 and the pump housing with the flange cover 5. The flange cover 5 is constructed as a cap-type cover and is configured to surround the guiding cover 6, there being provided on the edge a groove from which the cables extend.

The guiding cover 6 includes a first recess 7 within which the forked poles 2 of the motor 1 are received. In the center, there is provided a second recess 9 which surrounds the shaft of the motor 1. Within the structure of the guiding cover 6 which is constructed as a flat wide ring, consequently, there is produced a groove 10 which communicates with the first recess 7. The groove 10 includes a first extent region 11 extending perpendicularly to the forked poles 2, a second extent region 12 which extends so as to bend inwardly from the outer diameter, and a third extent region 13 which extends so as to bend outwardly back towards the outer diameter. In a fourth extent region 14, the groove 10 opens into a third recess which communicates with an outlet opening 15. The outlet opening 15 can be constructed as an elongated slot or one or more apertures formed in the peripheral edge 16 of the guiding cover 6. As seen in FIG. 1, the groove 10 is configured, in this non-limiting example, to be symmetrical and define a pair of mirror-symmetrical groove paths with respect to a center axis through the electrical contacts 2 and the outlet opening 15.

During the assembly and contacting of the electric motor 1, the forked poles 2 are connected to the ends 17 of the cables which can advantageously be carried out by means of soldering, but also by means of mechanical crimping or screwing. Subsequently, the cables are placed in the groove paths and guided outwardly through the outlet opening 15. Thereafter, the outlet opening 15 is closed by a suitable sealing means being introduced thereon, or the outlet opening 15 is closed in a sealed manner by means of silicone. The flange cover 5 is subsequently applied and screwed to peripheral flange 3 of the motor 1. The motor 1 is sealed therewith.

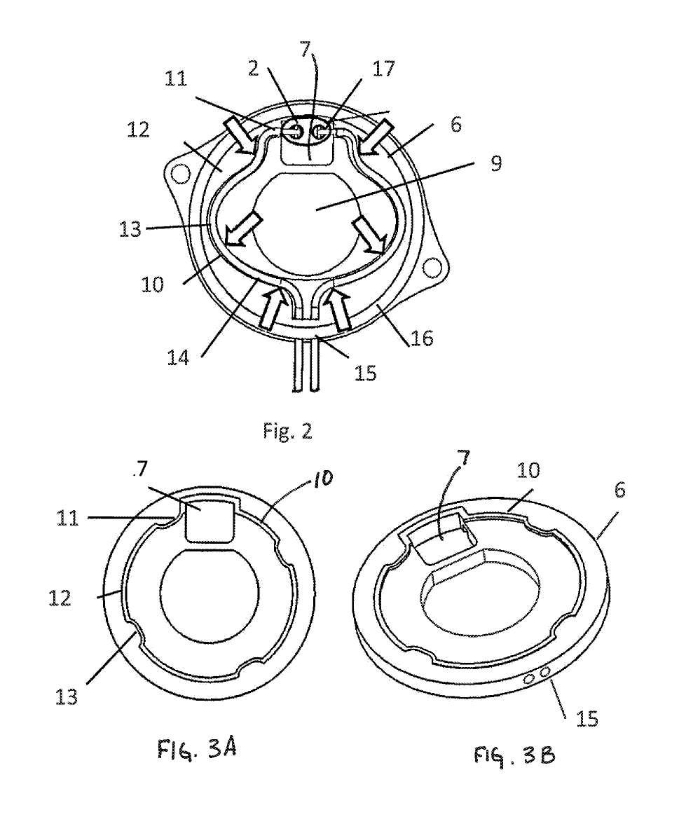

The soldering or other connections at the forked poles 2 of the motor 1 are not loaded up to the point of reaching the breaking limit since the geometry of the meandering guide paths in the groove 10 of the guiding cover 6 ensure that the tensile force is redirected into surface pressure and static friction. In FIG. 2, there are drawn for this purpose, a plurality of arrows which illustrate the supporting function of the groove 10 and the guiding cover 6 relative to the cables.

The sealing of the motor 1 is carried out by means of the edge 16 of the guiding cover 6 and the sealing of the outlet opening 15 for the cables.

The shape of the groove 10 may in this instance be freely configured in order to absorb the tensile force on the cables.

In FIGS. 3A and 3B, an alternative embodiment of the guiding cover 6 is illustrated. The guiding cover 6 has a groove 10 which has different regions. Starting from the recess 7 for the forked poles 2, a first region 11 extends at the left with an indentation from the edge of the guiding cover 6 in an inward direction. A second region then follows substantially parallel with the outer radius of the guiding cover 6 followed by another indentation in a third region 13. In this instance, the arrangement in this example is not symmetrical with respect to the recess 7 with the forked poles 2. It is purely a matter of transferring force to the guiding cover 6 by changing direction in the path of the groove 10 and relieving the connection location with respect to the forked poles.

The position of the recesses in the guiding cover 6 is determined by the motor shaft which is always arranged centrally. The electrical contacts, for example, the forked poles 2, are preferably arranged at the edge of the electric motor. In order to ensure optimum relief of the contacts with respect to tensile forces, it is advantageous to select an arrangement in which the electrical contacts are diametrically opposed to the outlet opening of the cables.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### LIST OF REFERENCE NUMERALS

1 Electric motor
2 Forked poles
3 Peripheral flange
4 Axial direction
5 Flange cover
6 Guiding cover
7 First recess Cable
8 Second recess
9 Groove
10 First extent region
11 Second extent region
12 Third extent region
13 Fourth extent region
14 Outlet opening
15 Peripheral edge
16 Cable end

1. A pump having an electric motor, the electric motor being fitted to the pump with a flange and having an electrical contact at the end face of the electric motor, wherein the electric motor is covered with a guiding cover which has a groove extending from the electrical contacts as far as an outlet opening for laying cables, wherein the groove makes at least one radial direction change and a peripheral edge of the guiding cover seals the electric motor with respect to a flange cover of the pump with sealing of the outlet opening.

2. The pump according to claim 1, wherein the guiding cover comprises a plastics material.

3. The pump according to claim 1, wherein the guiding cover has at least one recess for the electrical contacts and a motor shaft.

4. The pump according to claim 1, wherein the guiding cover is placed on the flange of the electric motor.

5. The pump according to claim 1, wherein the guiding cover is surrounded by the flange cover of the pump.

6. The pump according to claim 1, wherein the guiding cover has a structural height which corresponds at least to the thickness of the cable.

7. The pump according to claim 1, wherein the guiding cover has mirror-symmetrical groove paths with respect to a center axis through the contacts and the outlet opening.

8. The pump according to claim 1, wherein the guiding cover has opposing uniform groove paths with respect to a center axis through the contacts and the outlet opening.

9. The pump according to claim 1, wherein the guiding cover does not have any mirror-symmetrical or opposing uniform groove paths with respect to a center axis through the contacts and the outlet opening.

10. An electric pump comprising:
an electric motor having a motor shaft rotatable about an axis, at least one electrical contact extending outwardly from an end face and aligned to be generally parallel with the axis, and a mounting flange;
a guiding cover disposed on the end face of the electric motor and configured to include a first recess within which the electrical contact is received, a second recess through which the motor shaft extends, a third recess communicating with an outlet opening, and a groove extending between the first and third recesses, the groove configured to make at least one radial direction change;
a cable retained in the groove and having a first segment located in the first recess and being electrically connected to the electric contact and a second segment located in the third recess and extending through the outlet opening; and
and a pump driven by the motor shaft and having a pump housing with a flange cover sealed with respect to a peripheral edge of the guiding cover and being secured to the mounting flange of the electric motor.

11. The electric pump according to claim 10, wherein the outlet opening is sealed following the flange cover of the pump housing being secured to the mounting flange of the electric motor.

12. The electric pump according to claim 10, wherein the flange cover of the pump housing is cap-shaped and configured to surround the guiding cover.

13. The electric pump according to claim 10, wherein the groove defines a pair of groove paths each configured to extend between the first recess and the third recess, wherein the cable includes a pair of cables each disposed in a corresponding one of the pair of groove paths.

14. The electric pump according to claim 13, wherein the groove paths are symmetrical with respect to a center axis extending between the first and third recesses.

15. The electric pump according to claim 13, wherein the groove paths are configured as opposing uniform groove paths with respect to a center axis extending between the first and third recesses.

16. The electric pump according to claim 13, wherein the pair of groove paths are not symmetrical or uniform in configuration with respect to a center axis extending between the first and third recesses.

17. The electric pump according to claim 10, wherein the outlet opening includes a pair of apertures extending through the peripheral edge of the guiding cover.
